(19) United States
(12) Patent Application Publication
(10) Pub. No.: US 2006/0195832 A1
(43) Pub. Date: Aug. 31, 2006

(54) Modules for composing computer systems

(75) Inventors: Adrian Chandley, Sammamish, WA (US); Seiya Ohta, Issaquah, WA (US); Christopher A. Schoppa, Redmond, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 11/066,583

(22) Filed: Feb. 25, 2005

(51) Int. Cl. G06F 9/44; G06F 9/46

(52) U.S. Cl. 717/168; 719/321

(57) ABSTRACT

Described is a method and system comprising solution modules that allow a user to compose a customized computer system configured according to a user's needs. Modules may be by simply coupling them to a base computer system. Each module contains the hardware that enables a base computer system to accomplish a limited computing task, along with supporting software that is loaded to enable the base computer system to operate the hardware. The present invention thus provides an additive model, in which each module contains one or more hardware components, drivers and application programs, operating system modules, middleware and/or services that allow a user to compose a custom computer system. Examples of solution modules include an Internet module comprising a NIC and supporting software, a module that augments a computer system with digital video recorder capabilities, modules for advanced graphics subsystems such as for games, and others.

### FIELD OF THE INVENTION

The invention relates generally to computer systems, and more particularly to computer system modules.

### BACKGROUND OF THE INVENTION

Contemporary platforms for personal computers are arranged to deliver a rich, common set of services and features. These services and features provide the capabilities that other, separate products, such as hardware devices, application programs and other components augment. This model has worked well as personal computing has evolved, with separate products being developed in a number of general categories, e.g., work applications such as word processors and spreadsheets, media players, photography programs and devices, game programs and devices, messaging, email applications, Internet browsing and many others.

However, not every user requires all of the available services and features all of the time. For example, a typical user at work will not need the functionality that allows television shows to be recorded, but some users might like that functionality while at home rather than having to buy an expensive, dedicated device for such a purpose. Providing a full set of services and features creates a cost of entry issue when a potential customer is only interested in a small subset of the services and features available with contemporary platforms. While many users will still desire a rich, general-purpose computing platform, other users will not, and would prefer to pay for only what they need.

For instance, consider a customer that is only interested in Internet browsing and sending email. Today, such a user has to buy a package that supports not only Internet browsing, but also media playback, games, email, messaging and a host of other services and capabilities, along with product-specific features of a rich, end-user focused system. Instead of a model in which certain users are able to buy what is really wanted, the trend is to enable ever more richer operating models.

What is needed is a way to provide users who want more-limited functionality from computer systems with options that better match their particular objectives. At the same time, such a solution should be simple to use, and extensible to allow users with the ability to adapt their computer systems as their needs change.

### SUMMARY OF THE INVENTION

Briefly, the present invention provides a system and method in which one or more separable modules containing both hardware and software may be added to a base operating system platform, to provide a computer system configured according to a user's needs. For example, if a given customer wants a particular subset of features, that customer may purchase an add-in package comprising hardware and software, combined into a solution module that can be coupled to a computer system by physical or wireless connection. Each module contains the hardware that provides the base computer system with what it needs to accomplish a limited task, along with the supporting software that is configured and loaded, e.g., as new runtime objects by the base operating system. The software may include one or more drivers, and an application program that provides the base computer system with the ability to operate the hardware of the solution module. The application program provided with the solution module may do this directly, or indirectly, such as by downloading another program from the Internet.

Examples of solution module usage are diverse and numerous, and include a customer desiring Internet Browsing capability, who may purchase an Internet module containing a network interface card (NIC), drivers for the card and for an Internet protocol stack, a browser, and possibly a set of applications or web-based plug-ins such as media players and the like. Upon coupling the module in a suitable way to the computer system and connecting the network card to a live Internet connection, the software is installed and the user automatically given browsing capability. Customers that want their computer system to have digital video recorder capabilities (possibly in addition to other capabilities) purchase a solution module which may include disk storage, MPEG encoder/decoders and play and record software, and possibly a television tuner. Dependencies requiring more advanced graphics capability may also include an advanced graphics subsystem. Users desiring gaming capability purchase a module which may contain advanced graphics libraries, such as Microsoft Corporation's DX series, as well as an advanced graphics processor. Users who wish to exploit the capabilities of peripheral devices, e.g., to create a photo processing system, purchase a module containing the peripheral device and supporting software, such as camera image capture (from a camera peripheral), photo image processing, photo cataloging and image print (e.g., to a printer peripheral).

The present invention thus provides an additive model, in which each module contains a combination of one or more hardware components, drivers and application programs, possibly along with core operating system modules, middleware, services and the like that allow a user to assemble a custom computer system that matches his or her needs by simple coupling operations. Moreover, different modules may be combined at different times in different ways, to perform limited computing tasks without requiring fully-featured computer systems.

For example, a user may couple a laptop to a digital video recorder module comprising a hard drive, and software that provides communication and recording (e.g., encoding and timing) functionality. The laptop, which runs user interface software provided with the module, and which may have previously downloaded the programming guide, provides an Internet connection and user interface by which the user programs the personal video recorder to record. Once configured, the video recorder records the program, independent of whether the laptop is decoupled from the video recorder hardware. Thus, a personal video recorder may be provided that does not require any buttons, remote control, internal user interface (e.g., on-screen display), programming guide downloading capabilities, and so forth. At the same time, the user is not required to have the laptop dedicated to being a personal video recorder.

Other advantages will become apparent from the following detailed description when taken in conjunction with the drawings, in which:

### BRIEF DESCRIPTION OF THE DRAWINGS

FIG. 1 is a block diagram representing a general purpose computing device in the form of a personal computer system into which the present invention may be incorporated;

FIG. 2 is a general representation of software and hardware components including hardware and software added via a coupled solution module in accordance with various aspects of the present invention;

FIG. 3 is a block diagram generally representing a solution module including hardware and software for composing a computer system, in accordance with various aspects of the present invention;

FIG. 4 is a flow diagram representing example logic that handles coupling of a module to a base computer system, in accordance with various aspects of the present invention; and

FIG. 5 is a block diagram generally representing an example of selectively composing a computer system to handle digital video recording, in accordance with various aspects of the present invention.

### DETAILED DESCRIPTION EXEMPLARY OPERATING ENVIRONMENT

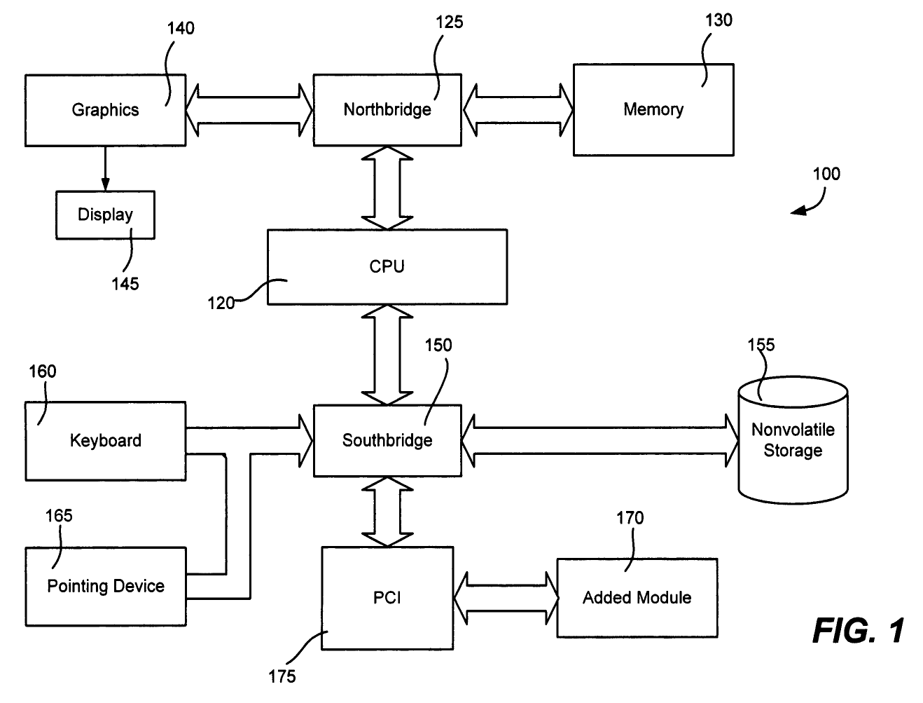

FIG. 1 illustrates an example of a computer system 100 into which the invention may be implemented. The computer system 100 is only one example of a suitable computing environment and is not intended to suggest any limitation as to the scope of use or functionality of the invention. Neither should the computer system 100 be interpreted as having any dependency or requirement relating to any one or combination of components illustrated in the computer system 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer, as well as hardware modules and hardware-based software modules. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose base computing system 100 which may include, but is not limited to, a processing unit (CPU) 120, coupled via a bus and northbridge 125 to a system memory 130, and to a graphics subsystem 140 that is connectable to a display 145. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 typically works with a variety of computer-readable media, although, in keeping with the present invention as described below, a computer may be configured to work with only the types of media that are desired by a user. Computer-readable media can be any available media that may be accessed by the computer system 100, and include both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) and random access memory (RAM). A basic input/output system (BIOS), containing the basic routines that help to transfer information between elements within computer 100, such as during start-up, is typically stored in ROM. RAM typically contains data and/or program modules that are immediately accessible to and/or presently being operated on by the processing unit 120. By way of example, and not limitation, RAM typically includes an operating system, application programs, other program modules and program data. In keeping with the present invention and as described below, however, the operating system is not necessarily full featured, but rather may provide a basic set of functionality that allows features to be added to it via modules, as desired by a user.

The computer system 100 may also include other removable/non-removable, volatile/nonvolatile computer storage media. By way of example, in FIG. 1 a southbridge 150 couples storage 155 such as a hard disk drive to the processing unit 120 for nonvolatile storage. A hard disk drive is typically connected to the system bus through a hard disk controller and suitable interface, e.g., ATA or SCSI-based interfaces. Other types of storage include a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media provide storage of computer-readable instructions, data structures, program modules and other data for the computer system 100.

A user may enter commands and information into the computer system 100 through input devices such as a tablet or electronic digitizer, a microphone, a keyboard 160 and pointing device 165, commonly referred to as mouse, trackball or touch pad. A user may also input video data via a camera. Other input devices may include a joystick, game pad, satellite dish, scanner, or the like. These and other input devices are often connected to the processing unit 120 through an interface that is coupled to the system bus via a southbridge 150, but may be connected by other interface and bus structures, such as a parallel port, firewire port, wireless (e.g., Bluetooth or infrared) connection, game port or a universal serial bus (USB). A monitor or other type of display device is also typically connected to the system via a video interface. The monitor may also be integrated with a touch-screen panel or the like. Note that the monitor and/or touch screen panel can be physically coupled to a housing in which the computing device 100 is incorporated, such as in a tablet-type personal computer. In addition, the computer system may also include other peripheral output devices such as speakers and a printer, which may be connected through an output peripheral interface or in various other ways.

The computer system 100 may operate in a networked environment (e.g., WAN and/or LAN) using logical connections to one or more remote computers, which may be a personal computer, a server, a router, a network PC, a peer device or other common network node, and often includes some or all of the elements described above relative to the computer system 100. Such networking environments are commonplace in offices, enterprise-wide computer networks, intranets and the Internet.

Modules for Composing Computer Systems

In accordance with various aspects of the present invention and as represented in FIG. 1, a solution module 170 is coupled to the base computer system 100 in some way and thereby provides some feature, service or other functionality that typically serves a limited computing need. For example, as represented in FIG. 1, the solution module 170 can connect through a PCI-based architecture 175, such as PCI Express, a high-bandwidth/high-speed, serial mechanism for interconnecting computer hardware via a rich, multi-master, disparate power bus. The southbridge 150 supports such a bus.

In general, the solution module 170 comprises a combination of enabling hardware and software packed in a suitable manner, such as a Server I/O (SIO) module, an example form factor for a self-contained module that can operate on a PCI Express bus. Essentially any other way of coupling a solution module to a computer system that allows data communication is feasible, and includes connection via parallel port, firewire port, wireless (e.g., Bluetooth, infrared and/or wireless LAN) connections, LAN connections, game ports, a universal serial bus (USB) connection, docking station-like connectors, rack mounting connectors, and so forth. Such solution modules provide the hardware and software that is needed to augment a base computer system to provide a feature, service or other functionality, without significant user involvement other than essentially making a physical or wireless connection.

As one example of composing a limited computer system, consider a customer that desires a computer with Internet browsing capability. The user may purchase an “Internet” (or other aptly named) solution module that contains a network interface card (NIC), drivers for the card, an Internet protocol stack, browser code, and a set of applications or web-based plug-ins such as one or more media players. When the solution module is connected to a base computer system, the software is installed (if not already present). The user then has an Internet-ready computer system. In essence, the user need only connect a broadband Internet connection to the NIC (e.g., via a jack in the solution module), and connect the solution module to the base computer system. In this way, even non-sophisticated users can compose their computer systems simply by making connections. A modem-based Internet solution module is similarly feasible, with the user plugging in a telephone line instead of a broadband connection.

Other types of solution modules include a module that, when coupled to a computer system, automatically composes the computer system into an email server. A web server or file server may be similarly composed, possibly in the same computer system or in a computer system that also serves another purpose. Note that such composed devices may have their settings configured (and be maintained as needed) via a temporary connection to another personal computer. Alternatively, a display, video card, keyboard and/or mouse can be used for configuration and then unplugged, and reconnected as needed for maintenance. In this manner, the composed server need not have their own display capabilities or input mechanisms, thereby lowering their production cost. Along with a processor, ROM and RAM, essentially all that is needed is a hard drive, networking hardware and appropriate software, and these items may be provided via the module.

As will become apparent, the present invention is extensible, including that at a later time, the user can add other types of solution modules that provide other functionality as needed. The user can also add other applications and use the hardware of another module, e.g., a user may by networking-related software without needing to buy another NIC if an Internet module was previously purchased. A user can connect another (limited or full-featured) computer system to the limited base computer and/or to a solution module to provide a more powerful personal computer.

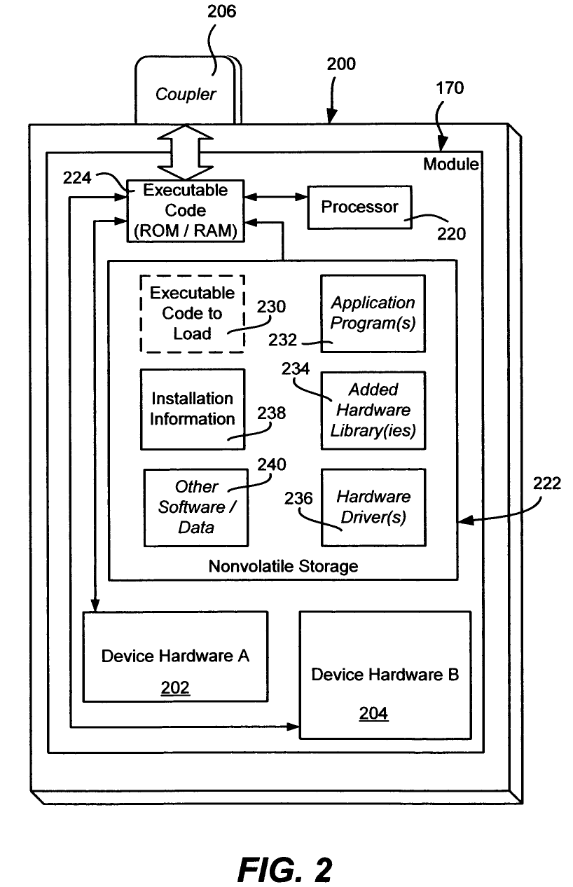

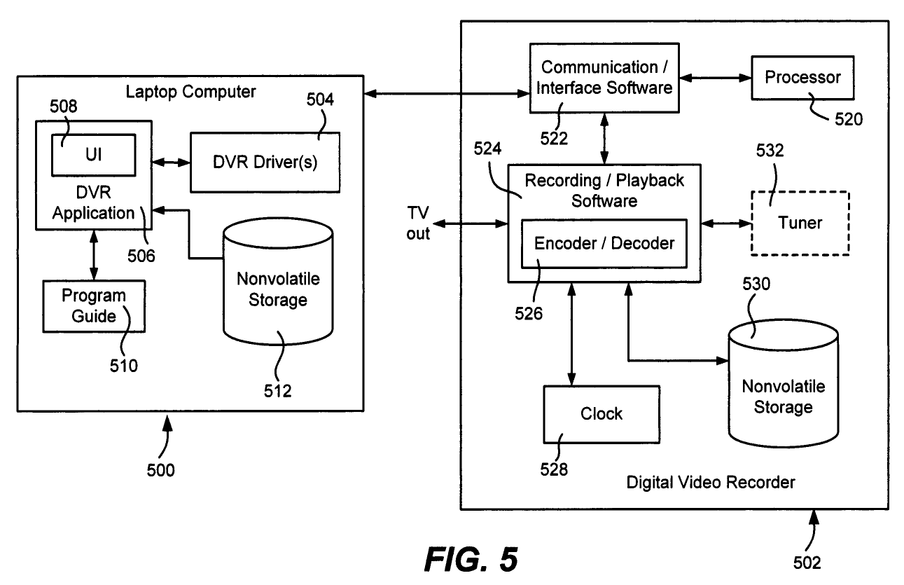

FIG. 2 shows the general concept of a solution module 170 in a container 200 that includes two hardware devices A and B, also labeled 202 and 204 respectively. Note that two devices 202 and 204 are shown in FIG. 2 for purposes of example, but that any practical number is feasible. For example, as described below with reference to FIG. 5, a personal video recorder module may include a hard drive plus a television tuner, while an Internet solution module would likely provide a single hardware device, the NIC.

The container 200 includes at least one coupler 206 that allows the module to connect to a computer system. The coupler 206 may be a physical connector that directly couples to a computer system, or one that connects via a wire. The coupler 206 may include a radio and antenna for wireless communication.

The module 170 includes a processing mechanism 220 that runs code 224 to access volatile storage 222 (e.g., flash memory) and to facilitate communication by running executable code 224, e.g., in ROM or loaded into RAM from a file 230 or the like in the nonvolatile storage 222, such as via ROM instructions at startup. Other code and data (possibly compressed) in the nonvolatile storage 222 associated with the added hardware may include one or more application programs 232, libraries 234 and/or drivers 236. Installation information 238 (e.g., a description of what software needs to be installed on the base computer system and any special instructions) and other software and data 240, such as infrastructure information, plug-in components, promotional or free (e.g., free document reader) software, and a user license/key, encryption codes and so forth also may be present in the module 170. Note that if one of the hardware devices is itself a nonvolatile storage device, such as a hard disk drive, then the nonvolatile storage 222 may be in such a device, rather than in separate storage. Further note that the executable code 224 may be in memory that allows execution-in-place (XIP).

The module 170 may be powered separately or may use the computer system's power, generally depending on its usage and connection mechanism. For example, an internal PCI-based module such as a NIC card would use the computer system's power, while a video recorder module could use an external power source so that it could still continue to operate when decoupled from a computer system. A USB device may operate either way, or both (e.g., using the computer power for communication and an external source for charging a battery, when connected).

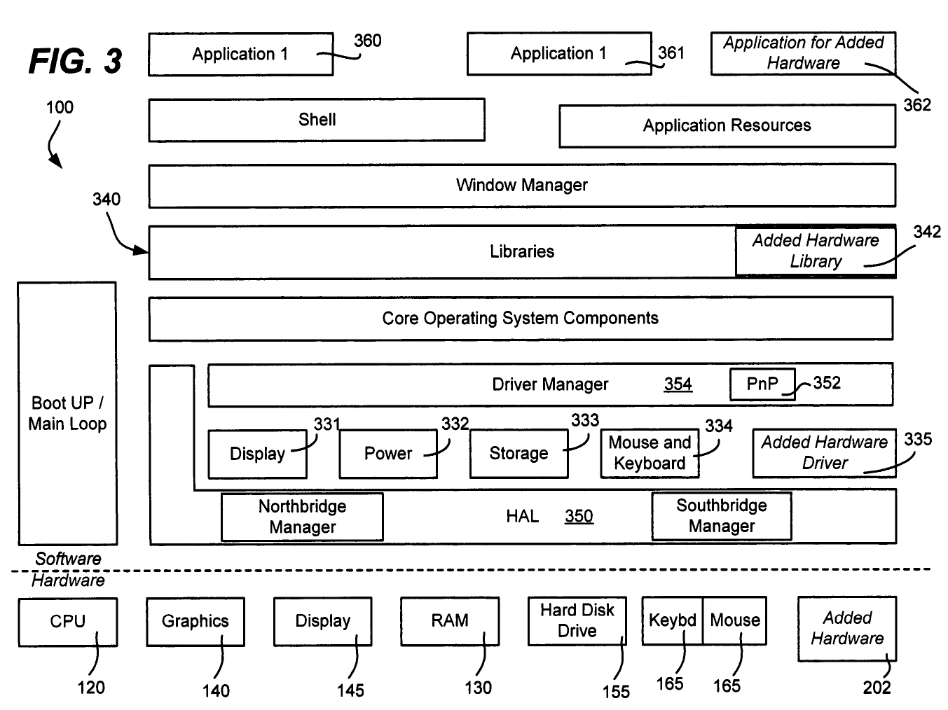

FIG. 3 represents how the software and hardware conceptually look when the solution module is connected to compose a base computer system, with software from the solution module installed and loaded into various layers. Note that a Windows®-based operating system supports a GUI interface, application launch, basic process scheduling and a plug and play discovery and integration model for hardware and software.

In FIG. 3, hardware devices include those shown in the base computer system 100 of FIG. 1, along with hardware (e.g., the device 202 of FIG. 2) added via the solution module 170. As can be seen, the driver layer includes drivers 331-334 for the hardware that requires a driver, along with a driver 335 for the added hardware of the solution module 170. Similarly, the library layer 340 is shown as including a library 342 for the added hardware, if one is needed. The layer for applications 361 and 362 also includes an application program 363 for the added hardware of the solution module 170. Although not shown in FIG. 3, the core operating system may be augmented via code installed from the module.

Turning to an explanation of the operation of the invention, to compose a computer system, a user couples the solution module 170 to the base computer system. In one example implementation, the SIO module 170 is powered, upon coupling or independently, and the coupling and/or power-up generates a plug-and-play connection/insertion event. In this example implementation, the plug-and-play event is passed up via the HAL layer 350 to a plug and play (PnP) component 352 of the driver manager 354. The plug-and-play event initiates a unpackage SIO module process, and in turn, the unpackage process may dynamically load software components into the Windows® operating system stack, set the new software system configuration and introduce the new features to the customer through the shell program 370. This process also configures the driver manager 354 to be able to work with the new hardware component 202. One suitable installation mechanism is described in U.S. patent application Ser. No. 10/864,409 entitled “Self-Installing Computer Peripherals,” assigned to the assignee of the present invention and hereby incorporated by reference.

Once installed the first time, the operating system can thereafter recognize the module upon re-coupling, whereby the library, driver and/or application need not be unpackaged again. Note that the software on the module may comprise a basic set of software that provides some minimal functionality, and may have been upgraded (e.g., via an Internet connection) by the user or by the module itself, and the user will not want upgraded versions replaced with older versions upon each re-coupling.

In another implementation, the module can hold off identifying itself for plug-and-play purposes until any other module-controlled operations are performed. For example, if an operating system that is not configured to work with self-installing peripherals sees that a type of hardware device has been connected, the operating system may attempt to locate and install a driver for that type of hardware device, when in fact the correct driver is on the solution module. By deferring plug-and-play identification until the module takes some triggering action, such as having the operating system automatically run an installation program loaded from the module, rather than install a hardware driver, the module's program can get the correct driver of the module prepared for installation, and then identify the hardware device to the operating system as necessary, e.g., by identifying itself to cause a plug-and-play event.

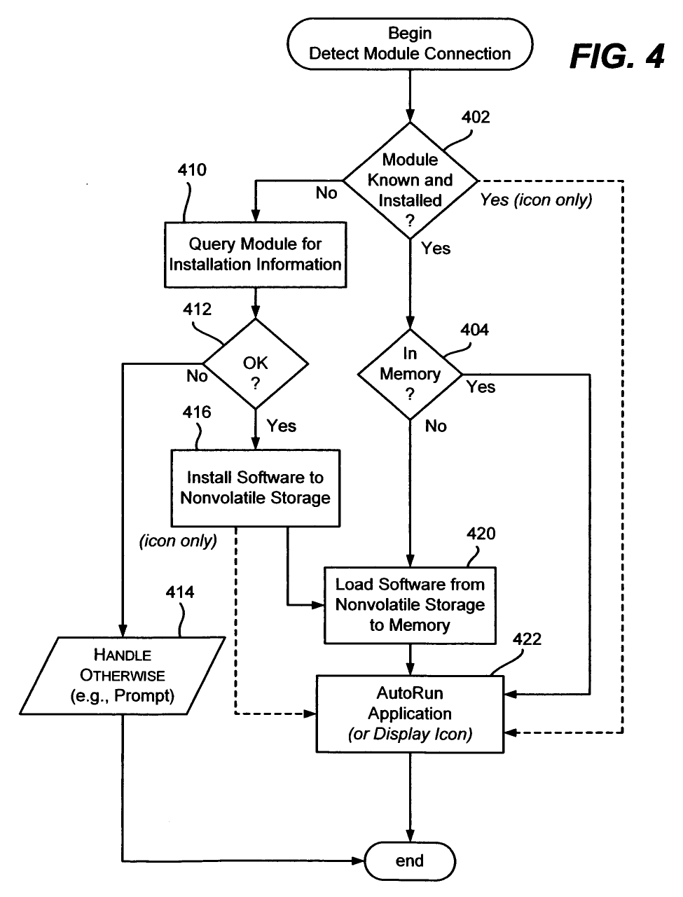

As represented by the flow diagram of FIG. 4, upon device connection, the computer system may detect (step 402) whether the device is known as having been previously installed. If so, steps 404 and 420 load the associated software (e.g., driver 335, library 342 and application 362) into memory as necessary, and the application program corresponding to the newly-connected device may be automatically run at step 422. Alternatively, rather than automatically running the module's associated application program, an icon or the like may be presented (or activated from an inactive state) which the user can then click to load and run the software. In such an event, step 402 bypasses the loading of the software, instead waiting for the user to actuate the icon before loading, as alternatively represented via step 422; note that the driver may be loaded. The choice of providing an icon versus automatically running the program may be user configurable.

If the module is not recognized at step 402 as having its software previously installed, step 404 is executed, where the coupled (unknown) hardware is queried for its installation information. If the coupled hardware is indeed a self-installing solution module in accordance with the present invention, as opposed to another hardware device, the module will respond appropriately as detected by step 412. If not self-installing, step 412 will branch to step 414 to handle otherwise, such as via traditional plug-and-play handling.

Step 416 represents the installation of the software, e.g., the initiating of the unpackage SIO module process, and the subsequent installation. When finished, the software may be loaded into memory as represented by step 420 and automatically run at step 422, or alternatively an icon may be displayed at step 422, whereby the user selects when to run the application program. A general result is that once coupled, the computer user has a product with the desired feature, without having to incur cost for capability that is not being used.

As described above, there are various ways that a base computer system can be augmented by coupling to a solution module. FIG. 5 is one example, where a solution module works with a laptop computer 500 to compose a computer system having a digital video recorder (DVR) 502. As will be understood, there are distinct advantages to the solution module over conventional digital video recording devices. One such advantage is that the solution module need not necessarily have a user interface, remote control, Internet (or other e.g., telephone) network connection software, and so forth, which may significantly lower its cost. Another advantage is that the solution module can operate with basic recording and/or playback functionality even when decoupled from the computer system 502, whereby the digital video recorder solution module frees the user's laptop computer for other uses. Note that a laptop computer 500 is used in this example to emphasize that functionality may remain with each device even after decoupling, however it can be readily appreciated that a desktop computer system or the like may be used with a digital video recorder solution module, whether permanently or only occasionally coupled as needed.

As represented in FIG. 5, the laptop computer 500 includes one or more drivers 504, and a digital video recorder (DVR) application program 506, including a user interface (UI) component 508. The application program 506 may control the operation of the digital video recorder 502, including programming it to record a show, copying content to and from it, and so on. Note that the application program that is loaded from the module need not directly perform the control functionality, but rather may be run for the purpose of downloading another program from the Internet or other source to control the recorder operation. Thus, in keeping with the present invention, the software components installed on the laptop computer 502 are installable from the solution module, e.g., during the initial coupling, as described above, but may be upgraded or replaced via the Internet or the like.

Because the laptop computer 500 has a display and input device such as a keyboard and mouse (not shown in FIG. 5), the digital video recorder 502 can be programmed by running the user interface 508 when coupled to the laptop computer 500. As a result, the digital video recorder 502 does not require its own user interface functionality. Note that an internal user interface (e.g., operated by buttons or a handheld remote control device and appearing on a television screen) may still be provided with the digital video recorder 502, but even if so, the user interface 508 of the laptop computer 500 can use a full screen, full keyboard and pointing device to provide a more user-friendly experience.

Moreover, the laptop computer 500 may acquire a program guide 510 via an Internet connection, independent of whether coupled to the digital video recorder 502. As a result, the digital video recorder 502 need not have an Internet connection, because the user can access the program guide 510 via the laptop computer 500 for programming purposes. The program guide 530 may be transferred to the digital video recorder 502, such as if the digital video recorder 502 has a user interface that can use it. Similarly, the laptop computer 500 can be used to purchase pay-per-view events, with a proper key or the like provided to the digital video recorder 502 as necessary to enable the event to be recorded.

As described above, the coupling between the laptop computer and the digital video recorder 502 may be by wired or wireless connection, or some combination of connection types. For example, wireless may be sufficient for programming the digital video recorder to record a show and otherwise controlling its operation, but a higher-bandwidth connection such as PCI express or USB may be a better choice for transferring recorded content to and from nonvolatile storage 512 of the laptop computer 500.

The digital video recorder 502 includes a processor 520 and software 522 that can communicate with the laptop computer when connected. The communication/interface software 522 in FIG. 5 represents the initial solution module installation-handling code, as well as code that handles normal data communication that takes place once the module's software has been installed on the laptop computer 500. Also represented in FIG. 5 is code 524 that handles recording and playback, e.g., including an encoder/decoder 526 that respectively write to and read from the nonvolatile storage 530 of the digital video recorder 502.

FIG. 5 also shows a clock 258 so that the digital video recorder 502 can be programmed to operate on a timed basis. An internal tuner 532 may be present, and/or the digital video recorder 502 may be arranged to receive digital or analog television signal input from an external source. FIG. 5 further shows a television (TV) out connection, which represents any suitable output mechanism or mechanisms, e.g., modulated output, video (e.g., composite, separated and so forth) and audio (e.g., mono or stereo) outputs. Note that the television output connection is not necessary to the digital video recorder 502, as the digital video recorder 502 may be configured such that it is only able to transfer content to the laptop computer 500 or another computer for playback. Such a closed system would allow the laptop computer 500 to handle digital rights management and the like, e.g., the recorded content may be encrypted and a key on the laptop required to decrypt the content for playback.

As can be seen from FIG. 5, a solution module thus augments a basic computer with digital video recorder functionality when coupled. When decoupled, the basic computer system may be used for other computing tasks, while the digital video recorder is still able to operate as programmed, e.g., to record a show. Again, in order to compose such a system, the user generally only needs to couple the digital video recorder module to the computer in an appropriate way, with power provided thereto.

Other types of solution modules include a module configured to turn a personal computer into a gaming system when coupled together, (and when a suitable display monitor is available). Along with the driver software, and application program software that allows a user to load and run a game (e.g., from the module directly, from a compact disk, from the Internet, and so forth), such a solution module may include a high-quality video card, and a game controller. The solution module may be built into the game controller. Note that PCI express has sufficient bandwidth to carry video information to a video card that is not part of the basic computer system, but rather is associated with the module or an external display. A key may be provided with the module to allows the user to download the game from the Internet when the module is coupled to any Internet-connected computer system. When decoupled, the game may be deleted by the application software to prevent unauthorized software and/or reclaim the host computer's storage space. In this manner, a user can physically take the module to a friend's computer, for example, and have the game run thereon.

Thus, via a solution module, a computer system such as a laptop computer with relatively limited internal video capabilities can be composed into a gaming system. In a similar manner, cellphone cameras and digital cameras can display video and still images with better quality than their own displays are capable of displaying.

A module can also be coupled to a personal computer to perform as an audio player/recorder. The personal computer can handle Internet downloading, compact disk burning, and so forth, with the solution module providing the software to perform such tasks. The solution module also provides the necessary hardware (e.g., amplifier, decoder, digital-to-analog converter, and/or stereo interface) to produce audio output. If the solution module has sufficient memory, e.g., a hard drive, the personal computer can download content and program the module with a playlist, whereby the solution module can continue to operate as an independent audio player even after decoupling from the computer system. Note that the solution module need not contain any user interface or CD drive to operate in such a manner, again enabling a lower-cost device. However, the module may provide such features along with other features as desired by the manufacturer.

Another aspect of the present invention allows a user to obtain desired functionality on a computer system that the user is only temporarily using. For example, a computer may be provided via a kiosk, hotel, or another person that has one available. A solution module may contain the software and/or license data such that when coupled to the other computer, the solution module gives the user some desired capability, possibly many or all of the capabilities of the user's owe personal computer such as the user's important application programs and the like. These programs may be on the solution module, but also may be downloaded from the Internet via the license/key as needed. Unlike installing a program from a disk or the like, the functionality is only temporarily present when the solution module is coupled. The programs thus travel with the user, but the user need not bring a laptop to have computing functionality, only have access to a computer, as the solution module leverages the capabilities of the other computer.

Another example of a solution module is a hard drive that continues to provide some functionality when not coupled to a computer system. For example, a module may provide an “intelligent” hard drive that acts as a regular hard drive when a personal computer is connected, for essentially any purpose including data backup or content recording/playing as described above. However, because the module includes processing power and some executable software, the module can be used for other purposes as well. For example, a digital camera can connect to the hard drive and download video and/or pictures, without a computer system involved. Such a solution module thus provides a computer system with a hard drive and limited functionality.

Yet another example includes a solution module that contains settings and the like to compose another computer system differently when connected. For example, a secure digital (SD) card or multimedia card (MMC) card may be plugged into a computing device, such as a smart mobile telephone. When connected, the card may modify the device with the settings that allow the telephone to access the Internet in Europe, for example. Such a card may be purchased or rented, with the account information thereon, and even handle tracking prepaid minutes.

As can be seen from the foregoing detailed description, there is provided a solution module system and method that allow computer system functionality to be separated and easily combined for usage, thereby providing users with lower-cost options that match their particular objectives. The solution modules are simple to use, and extensible to allow users with the ability to adapt their computer systems as their needs change.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. In a computing environment, a method comprising:
providing a solution module, the solution module including hardware, software including a driver and an application program, and a communication mechanism that allows the software module to communicate when coupled to another computer system;
executing software on the solution module to communicate with another computer system when coupled to that other computer system, including installing the driver and application program for execution on the other computer system; and
the driver in the solution module providing the application program, when run on the other computer system, with access to functionality of the solution module hardware to augment the capabilities of the other computer system.

2. The method of claim 1 wherein providing the other computer system with access to functionality of the solution module hardware includes performing a computer-related operation via the hardware of the solution module while the solution module is coupled to the other computer system.

3. The method of claim 1 wherein providing the other computer system with access to functionality of the solution module hardware includes allowing the other computer system to program the solution module to perform a computer-related operation, independent of whether the operation occurs after decoupling.

4. The method of claim 3 wherein allowing the other computer system to program the solution module to perform a computer-related operation includes programming the solution module to control audio and/or visual data input and/or output.

5. The method of claim 1 wherein providing the solution module comprises providing at least one other type of data from a set, the set containing, infrastructure-related software code, a software library, installation related software code, installation related software data, a plug-in software component, a promotional software program, user license data, a key, and encryption/decryption-related data.

6. The method of claim 1 wherein providing the solution module comprises providing at least one module from a set, the set comprising an Internet-access related module, a digital video recorder-related module, an audio player-related module, a game-playing related module, a graphics-related module, and/or a digital camera input-related module.

7. At least one computer-readable medium having computer-executable instructions, which when executed perform the method of claim 1.

8. In a computing environment, a system comprising:
a base computer system including a processor and memory;
a module configured to be coupled to the base computer system, the module comprising hardware and software including a driver and an application program, and a communication mechanism that allows the software module to communicate when coupled to the base computer system to install software onto the base computer system; and
the software installed on the base computer system when coupled, and thereafter providing the base computer system with access to functionality of the solution module's hardware to augment the capabilities of the base computer system.

9. The system of claim 8 wherein once installed on the base computer system, the application program causes downloading of another application program to provide the base computer system with access to the functionality of the module's hardware.

10. The system of claim 8 wherein once installed on the base computer system, the software performs a computer-related operation via the hardware of the module while the module is coupled to the base computer system.

11. The system of claim 8 wherein when coupled, the software installed on the base computer system programs a computer-related operation to occur via the hardware of the module, independent of whether the module remains coupled to the base computer system.

12. The system of claim 11 wherein allowing the solution module is programmed to perform a computer-related operation related to controlling audio and/or visual data input and/or output.

13. The system of claim 8 wherein the solution module includes at least one other type of data from a set, the set containing, infrastructure-related software code, a software library, installation related software code, installation related software data, a plug-in software component, a promotional software program, user license data, a key, and encryption/decryption-related data.

14. The system of claim 8 wherein providing the solution module comprises providing at least one module from a set, the set comprising an Internet-access related module, a digital video recorder-related module, an audio player-related module, a game-playing related module, a graphics-related module, and/or a digital camera input-related module.

15. The system of claim 8 wherein the module is coupled to a shared communications bus of the base computer system.

16. The system of claim 8 wherein the module is configured to be coupled to the base computer system via a wireless connection and/or a wired connection.

17. The system of claim 8 wherein the module hardware includes a hard disk drive and/or at least one other storage component.

18. In a computing environment, a module comprising:
means for coupling the module to another computer system;
means for installing software from the module onto the other computer system;
hardware means for performing data-related operations; and
means for communicating with the other computer system, including means by which the software installed on the other computer system allows the other computer system to access the hardware means to perform data-related operations via the hardware means.

19. The module of claim 18 wherein the means for communicating includes means for receiving instructions to perform a computer-related operation via the hardware of the module while the module is coupled to the other computer system.

20. The module of claim 18 wherein the means for communicating includes means for receiving programming instructions to later perform a computer-related operation via the hardware of the module, independent of whether the module remains coupled to the base computer system.
